(19) United States
(12) Patent Application Publication
(10) Pub. No.: US 2007/0053534 A1
(43) Pub. Date: Mar. 8, 2007

(54) Behind-the-ear speech processor for cochlear implant systems

(76) Inventor: Trifon Kiratzidis, Veria (GR)

Correspondence Address: BROMBERG & SUNSTEIN LLP, 125 SUMMER STREET, BOSTON, MA, 02110-1618, US

(21) Appl. No.: 10/564,850

(22) PCT Filed: Jun. 21, 2004
(86) PCT No.: PCT/GR04/00035

§ 371 Date: Nov. 3, 2006

(30) Foreign Application Priority Data
Jul. 16, 2003 (GR) 20030100301

(51) Int. Cl. H04R 25/00

(52) U.S. Cl. 381/312

(57) ABSTRACT

Behind-the-ear (BTE) speech processor for cochlear implant systems, which is constructed in such a way that it constitutes a single mechanical unit (drawing 6). The unit is composed of a single shell, which contains the microphone (drawing 7.1), the electronic processor (EP) (drawing 7.2), the inductive transmission coil (ITC) (drawing 7.3), the fixing magnet (drawing 7.5), the batteries or accumulators (drawing 7.6), the control buttons and switches (drawing 7.7), the external connections socket (drawing 7.8) and the embedded fixing hook (FH) (drawing 7.4), that overall constitute a one-piece system, without any mobile parts. Hence, the BTE consists of only one piece or section, without a separate ITC or cables. In order to position this single-piece BTE speech processor (SPBTE), a fixing hook that fits around the auricle and a magnet that fits on the magnet of the CI is used. Its combined double fixation and the absence of any cable are the main advantages of the invention, which ensure easy of use, freedom of body movement and no damages due to cable wear and tear.

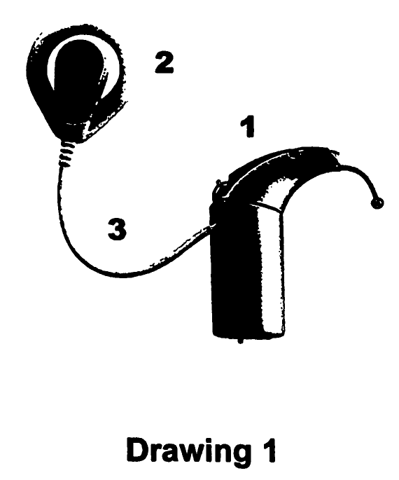

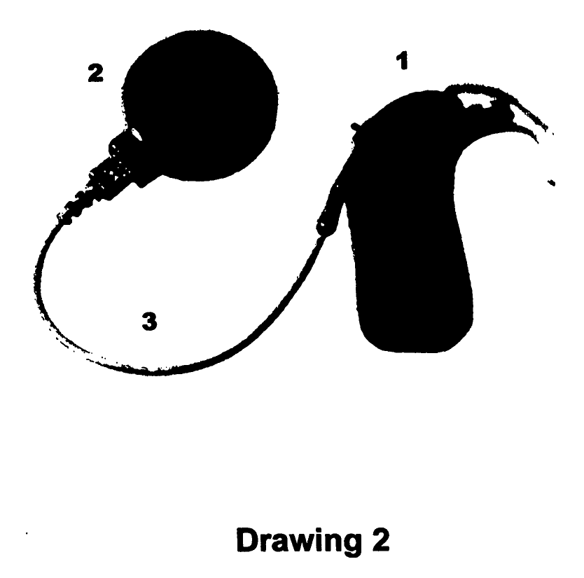

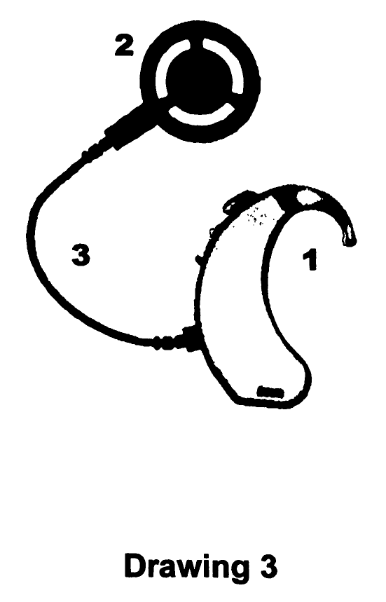

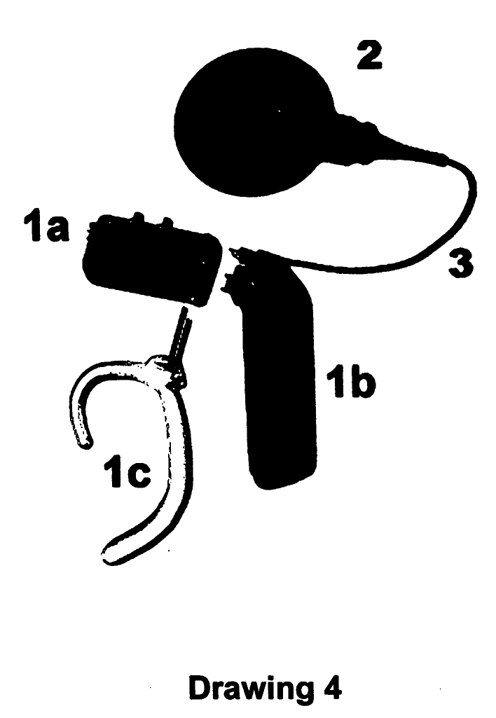

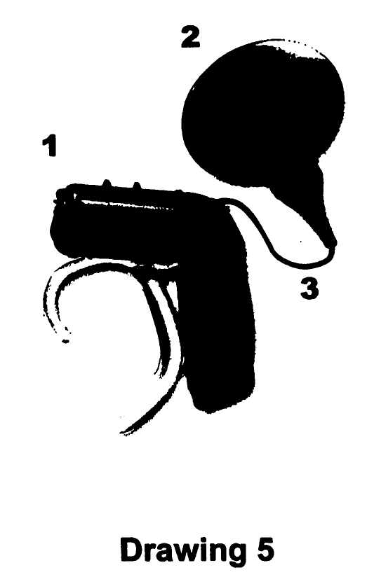

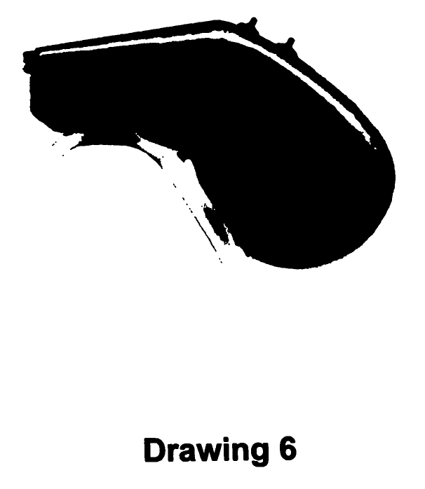

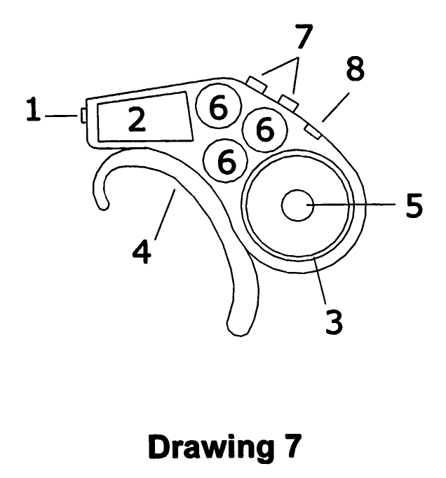

This invention refers to behind-the-ear speech processors for cochlear implant systems, which are used by deaf individuals that have undergone a cochlear implantation operation. With the use of the cochlear implant, deaf users can hear and communicate through hearing.

Cochlear implant systems (CIS) are high technology products and nowadays they constitute an established means of dealing with deafness. These systems consist of two functional parts: One part (internal), the so-called cochlear implant (CI), is a special receiver that is surgically implanted in the temporoparietal region behind the auricle. A special electrode array that proceeds from the CI, is inserted in the cochlea during the cochlear implantation operation and comes into contact with neural fibres of the acoustic nerve. The other part (external), the so-called speech processor (SP), receives environmental sounds in addition to human speech and, after special processing, transmits them wirelessly in the form of electric pulses to the internal part (CI), along with the required energy, thereby making it possible for deaf users to hear. The main components that constitute the SP are the microphone, the electronic processor of sound signals (EP) and the inductive transmission coil (ITC). The first two components (the microphone and the electronic processor of sound signals), are installed in a case that contains the batteries or accumulators that are required for the system to operate, as well as the system parameter controls (buttons and switches). Together they form the basic unit (BU) of the SP. The third part (ITC) is connected to the BU via a cable and is placed on the head of the individual that has undergone a cochlear implantation, exactly at the point where the CI was placed. The ITC is kept in place by the action of two small magnets that were installed inside the CI and ITC respectively during manufacture. The information, along with the required energy that the CI requires, since the CI does not contain any batteries, is transmitted from the ITC to the CI wirelessly, through the skin.

The SP may be a body-worn speech processor (BWSP), approximately the size of a cigarette packet, which is worn by the user somewhere on his body, belt or in a pocket, or a behind-the-ear type (BTE), in which case the SP is small in size, thereby enabling its placement behind the ear, just like a conventional hearing aid.

BTE speech processors were the result of progress in CISs that was made possible due to the evolution of microelectronics, which enabled the volume and weight of the device to be reduced. Compared with the BWSP, they offer considerable convenience to CIS users, providing freedom of body movement and dressing options, since they do not require the head (ITC) and body (BWSP) to be connected with cables. In addition they do not require any attempts to conceal these cables, which is particularly difficult during warm seasons and in warm climates where people dress lightly.

BTEs, however, have some drawbacks. The BU and the ITC are separate parts that are connected with a cable. We are familiar with this type of BTE from the websites of companies that manufacture them. Drawings 1, 2 and 3 illustrate the “ESPRIT 3G” BTE of the company “Cochlear”, the “Clarion CII” BTE of “Advanced Bionics” and the “Digisonic” BTE of the company “MXM”, respectively. The separate parts of the BU (1) and the ITC (2), which are at a distance from each other and are connected through a cable (3), are evident in all drawings.

In another application concerning the “Tempo+” BTE of the company “Med-EI”, as shown in drawing 4, the electronic processor (EP) (1a), the battery-pack (BP) (1b) and the fixing hook (FH) constitute separately manufactured parts. In this case, special sliding contacts allow the connection of the EP with the BP, which are secured with FH pins and, consequently, the BU is structured like a one-piece unit. This one-piece BU system is then connected to the ITC with a cable (3), thereby forming a system that is similar to the previous systems, which consist of two basic elements that are connected with a cable, as illustrated in drawing 5.

In order to wear BTEs like the ones described above, each of the two separate parts (BU and ITC) demand special attention by the user while positioning. Obviously, the BU is first fastened to the auricle, while the ITC hangs from the cable. The user then takes the ITC and searches the scalp in order to locate the exact position of the CI. The ITC is placed exactly above the CI. The correct position is indicated by the magnetic attraction exercised by the CI magnet on the ITC magnet. In some cases the first attempt to fix the ITC may be unsuccessful and a second attempt is necessary.

It is obvious that the whole procedure may be complicated, especially for a small child that has to go to school where parental care is not available.

The final positioning of the BTE components is separate: the BU is fixed on the auricle with a hook and the ITC on the CI by the action of the magnets. The two independently positioned components may become easily detached and the whole system may fall from the head if the user moves suddenly, something that is very usual with users that are manual workers and with small children.

Furthermore, users are required to replace the cables that are damaged by wear and sweat, especially in warm climates.

According to the Implementation of this patent, the BTE speech processor is constructed in such a way that it constitutes a single mechanical unit (drawing 6). The unit's BU, ITC, BP and fixing elements are included inside a single shell. Hence, the BTE speech processor consists of only one piece or section, without a separate ITC or cables. In order to position this single-piece BTE speech processor (SPBTE), a fixing hook that fits around the auricle and a magnet that fits on the magnet of the CI is used. The elements that form the SPBTE may constitute a single and fixed mechanical unit or may be mechanically connected by means of an articulated or elastic joint, permitting adjustment of the connection angle according to the needs of each individual user.

The advantage of the SPBTE structure is that the user may position the device behind the auricle with one simple movement. The hook embraces the auricle, which forms the device's initial support. The in-built magnet is fixed by the attraction exercised by the CI magnet, which, especially for this case, is positioned close to the auricle during the cochlear implantation operation.

As a result, the one-piece device is fixed simultaneously to the auricle and the CI magnet. This double fixing ensures the device's stability and offers increased freedom of movement to users and safety to small children.

Furthermore, the SPBTE offers additional advantages such as:

Users need no longer concern themselves with damages arising from cable wear and tear and the need to replace the cables.

Fixing the SPBTE solely to the auricle, without using magnets, may be sufficient, either through the use of a specially designed (moulded) hook, or by fixing the hook to eyeglass frames. Consequently, the CI that is implanted in the user will not include a magnet, which is very important for monitoring illnesses that require cranial MRI scans to be carried out.

Its design has the capacity to simulate widely used modem technology applications, such as a mobile phone blue tooth and free the user from the hearing aid stigma.

As mentioned above, the implementation of the SPBTE requires that the user undergo a special surgical technique in order to place the CI close to the auricle. This technique is less traumatic than the classic surgical technique and may be performed under local anaesthesia.

This invention may be fully understood from the following description of one of the ways in which it is utilised, in conjunction with the attached drawings 6 and 7. Drawing 6 illustrates an example of the final form of the SPBTE, whose characteristic feature is that it constitutes a single and compact mechanical unit, which has no moving components and no external cables.

According to the invention, and as illustrated in detail in drawing 7, the single section of the SPBTE contains all the necessary functional and fixing BTE parts: 1) microphone, 2) EP, 3) ITC, 4) FH, 5) magnet, 6) batteries or accumulators, 7) control buttons and switches, 8) external connection socket for connection with external microphone, teaching system for the hearing impaired (FM) and computer interface for adjustments and controls.

Alternatively, a rotating mechanical or elastic joint may be added between the horizontal and oblique sections of the SPBTE during the manufacturing process, in order for a variable angle to be obtained. That would enable its size and shape to be individually adjusted to each user.

Alternatively, the FH may be embedded in eyeglasses or sunglasses.

1. Behind-the-ear (BTE) speech processor for cochlear implant systems, whose characteristic feature is the fact that it constitutes a single mechanical unit (drawing 6). More specifically, all functional parts are contained in one shell: the microphone (drawing 7.1), the electronic processor (drawing 7.2), the inductive transmission coil (drawing 7.3), the fixing magnet (drawing 7.5), the batteries or accumulators (drawing 7.6), the control buttons and switches (drawing 7.7), the external connections socket (drawing 7.8) and the embedded fixing hook (drawing 7.4), that overall constitute a one-piece system, without any mobile parts.

2. Speech processor in accordance with claim 1, further characterised by the fact that the speech processor (drawing 7.2) and the fixing hook (drawing 7.4) may be manufactured as separate parts. Following, however, their final mechanical assembly and securing before they are used, they form a single system, without any mobile parts.

3. Speech processor in accordance with claim 1, further characterised by the fact that eyeglass or sunglass hooks may form the fixing hook (drawing 7.4).
